(19) United States
(12) Patent Application Publication
(10) Pub. No.: US 2022/0213388 A1
(43) Pub. Date: Jul. 7, 2022

(54) HYDROTREATMENT OF OXYGENATE FEEDSTOCK WITH LIQUID RECYCLE FROM LOW PRESSURE SEPARATOR

(71) Applicant: HALDOR TOPSØE A/S, Kgs. Lyngby (DK)

(72) Inventors: Ole Frej ALKILDE, Valby (DK); Gordon Gongngai LOW, Santa Ana, CA (US); Steven W. STUPIN, Orange, CA (US)

(73) Assignee: HALDOR TOPSØE A/S, Kgs. Lyngby (DK)

(21) Appl. No.: 17/595,404

(22) PCT Filed: Jul. 2, 2020
(86) PCT No.: PCT/EP2020/068643

§ 371 Date: Nov. 16, 2021

Related U.S. Application Data
(60) Provisional application No. 62/870,853, filed on Jul. 5, 2019.

(30) Foreign Application Priority Data
Oct. 25, 2019 (DK) PA 2019 01259

(51) Int. Cl. C10G 3/00; B01J 19/00; C10G 45/48; B01J 19/24; B01D 19/00

(52) U.S. Cl. CPC C10G 3/50; B01J 19/0013; C10G 45/48; B01J 19/245; B01J 2219/00121; B01J 2219/0004; C10G 2400/04; C10G 2400/08; B01D 19/0036

(57) ABSTRACT

A hydrotreatment unit for an oxygenate feedstock is provided, the unit including: a hydrotreatment reactor; a first cooling unit; a high-pressure separator and a low pressure flash unit. The hydrotreatment unit is arranged to feed at least a part of the hydrogen-rich stream from the high-pressure separator to the hydrotreatment reactor; and the hydrotreatment unit is arranged to feed a part of the degassed hydrocarbon-rich stream from said low pressure flash unit as a hydrocarbon recycle stream to the hydrotreatment reactor. Also, a method for hydrotreating an oxygenate feedstock using the hydrotreatment unit.

### TECHNICAL FIELD

A hydrotreatment unit for an oxygenate feedstock is provided, said unit comprising: a hydrotreatment reactor; a first cooling unit; a high-pressure separator and a low pressure flash unit. The hydrotreatment unit is arranged to feed at least a part of the hydrogen-rich stream from the high-pressure separator to the hydrotreatment reactor; and the hydrotreatment unit is arranged to feed a part of the degassed hydrocarbon-rich stream from said low pressure flash unit as a hydrocarbon recycle stream to the hydrotreatment reactor. A method for hydrotreating an oxygenate feedstock using said hydrotreatment unit is also provided.

### BACKGROUND

Oxygenate hydrotreatment units often use liquid recycle to control temperatures in a hydrotreatment reactor. This liquid recycle can contain light impurities that—as they are sent back to the hydrotreatment reactor—reduce purity of the gas phase in the hydrotreatment reactor. Repeated recycling creates undesired build-up of light impurities. Particular impurities include CO, CO₂, C1, C3 and other light gasses.

For the conversion of oxygenate feedstocks into hydrocarbon transportation fuels, the feedstocks are together with hydrogen directed to contact a material catalytically active in hydroprocessing, especially hydrodeoxygenation. To moderate the release of heat, a liquid hydrocarbon may be added, e.g. a liquid recycle stream or an external diluent feed. The resulting product stream will be a hydrotreated intermediate product stream comprising hydrocarbons, typically n-paraffins, and sour gases such as CO, CO₂, H₂O and H₂S.

U.S. Pat. No. 9,447,339 concerns hydroprocessing of biodiesel fuels and blends. EP2121876 concerns a process for producing paraffinic hydrocarbons.

The present technology addresses the problems associated with known hydrotreatment units and techniques, primarily that such units are costly and inefficient.

### SUMMARY

A hydrotreatment unit for an oxygenate feedstock is thus provided, said unit comprising:
a hydrotreatment reactor; said hydrotreatment reactor being arranged to receive said oxygenate feedstock and convert it to a hydrotreated first hydrocarbon stream;
a first cooling unit arranged to receive said hydrotreated first hydrocarbon stream from said hydrotreatment reactor and cool it to a cooled second hydrocarbon stream;
a high-pressure separator arranged to receive the cooled second hydrocarbon stream from said first cooling unit and separate it into at least a hydrocarbon-rich stream, and a hydrogen-rich stream;
a low pressure flash unit, said low pressure flash unit arranged to receive the hydrocarbon-rich stream from said high-pressure separator unit and de-gas it; thereby providing an off-gas and a degassed hydrocarbon-rich stream,
wherein said hydrotreatment unit is arranged to feed at least a part of the hydrogen-rich stream from the high-pressure separator to the hydrotreatment reactor; and
wherein said hydrotreatment unit is arranged to feed a part of the degassed hydrocarbon-rich stream from said low pressure flash unit as a hydrocarbon recycle stream to the hydrotreatment reactor

with the associated benefit of providing a recycle configuration with a high gas purity.

In a further embodiment the hydrotreatment unit further comprises a hydroisomerization section located between said hydrotreatment reactor and said first cooling unit; and being arranged to receive said hydrotreated first hydrocarbon stream from said hydrotreatment reactor, perform catalytic hydroisomerization of said hydrotreated first hydrocarbon stream and provide a dewaxed first hydrocarbon stream to said first cooling unit with the associated benefit of providing a dewaxed hydrocarbon stream with good cold flow properties.

In a further embodiment the hydrotreatment unit further comprises a second heating or cooling unit located in said hydrotreated first hydrocarbon stream between said hydrotreatment reactor and said hydroisomerization section with the associated benefit of providing optimal conditions in said hydroisomerization section.

In a further embodiment of the hydrotreatment unit said hydrotreatment unit is arranged to provide a part of the degassed hydrocarbon-rich stream from said low pressure flash unit as a hydrocarbon product stream with the associated benefit of providing a commercial product from the hydrotreatment unit.

In a further embodiment of the hydrotreatment unit said off-gas comprises H₂, CO₂, C1 and C3 gaseous components with the associated benefit of withdrawing an amount of CO₂, C1 and C3 instead of directing it to the hydrotreatment reactor.

In a further embodiment the hydrotreatment unit further comprises an H₂ make-up feed, arranged to be combined with said H₂-rich stream so as to provide treat gas with the associated benefit of providing a high amount of H₂ in the treat gas.

In a further embodiment the hydrotreatment unit further comprises a first compressor arranged to compress the H₂-rich stream, with the associated benefit of providing the H₂-rich stream at high pressure conditions matching the pressure in the hydrotreatment unit.

In a further embodiment the hydrotreatment unit is arranged to combine said H₂-rich stream or said treat gas with said hydrocarbon recycle stream to provide a combined stream which is fed to the hydrotreatment reactor, with the associated benefit of providing H₂ to the reaction in the hydrotreatment unit.

In a further embodiment the hydrotreatment unit is arranged to combine at least an amount of said combined stream with at least a portion of oxygenate feedstock prior to being fed to the hydrotreatment reactor, with the associated benefit of providing H₂ to the reaction in the hydrotreatment unit, as well as the benefit of stepwise control of the reactor temperature, by adding an amount of cooled combined stream at an intermediate point in the reactor.

A further aspect relates to a diesel plant comprising the hydrotreatment unit and a separation unit, said diesel plant arranged such that at least a part of said degassed hydrocarbon-rich stream, is fed from said hydrotreatment unit to said separation unit and purified to provide a hydrocarbon product, such as a diesel product, jet fuel or feedstock to a petrochemical plant.

A further aspect relates to a method for hydrotreating an oxygenate feedstock using the hydrotreatment unit comprising the steps of:
i. feeding said oxygenate feedstock to the hydrotreatment reactor; and converting it to a hydrotreated first hydrocarbon stream;
ii. feeding said hydrotreated first hydrocarbon stream from said hydrotreatment reactor to said first cooling unit and cooling it to a cooled second hydrocarbon stream;
iii. feeding the cooled second hydrocarbon stream from said first cooling unit to said high-pressure separator, and separating it into at least a hydrocarbon-rich stream, and a hydrogen-rich stream;
iv. feeding the hydrocarbon-rich stream from said high-pressure separator to said low pressure flash unit, and de-gassing it; thereby providing an off-gas and a degassed hydrocarbon-rich stream,
v. feeding at least a part of the hydrogen-rich stream from the high-pressure separator to the hydrotreatment reactor;
vi. separating the degassed hydrocarbon-rich stream from the low pressure flash unit into a hydrocarbon product stream and a hydrocarbon recycle stream; and
vii. feeding said hydrocarbon recycle stream to the hydrotreatment reactor.

In a further embodiment of the method the low pressure flash unit operates at a pressure of between ambient pressure and 30 barg, preferably between ambient pressure and 15 barg, with the associated benefit of separating an off-gas comprising other gases than H₂ as well as a moderate amount of H₂ from the degassed hydrocarbon-rich stream.

In a further embodiment of the method the high pressure separator operates at a pressure of between 20-100 barg, preferably between 30-80 barg with the associated benefit of separating a hydrogen-rich stream comprising a moderate amount of other gases than hydrogen from the hydrocarbon-rich stream, such as 80 vol % H₂ or more.

In a further embodiment the method further comprises a step of performing catalytic hydroisomerization on the hydrotreated first hydrocarbon stream from said hydrotreatment reactor, and providing a dewaxed first hydrocarbon stream to said first cooling unit, with the associated benefit of carrying out hydroisomerization on sulfided base metal catalyst in the presence of sulfur.

In a further embodiment of the method the hydrogen-rich stream from the high-pressure separator is further cooled and separated in a further cold high-pressure separator before being directed to the hydrotreatment reactor; with the associated benefit of the hydrogen-rich stream comprising an even lower amount of other gases than hydrogen from the hydrocarbon-rich stream, such as 80 vol % H₂ or more. The liquid of the cold high-pressure separator may be further separated in a low pressure separator and may either be directed as a hydrocarbon recycle stream to the hydrotreatment reactor or to a fractionator for separation into product.

### LEGENDS

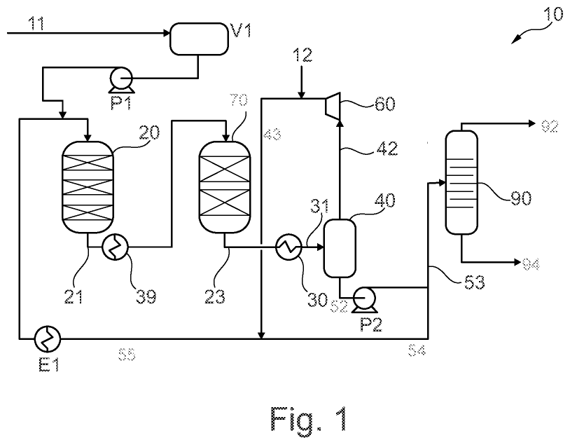

FIG. 1 shows a simplified illustration of a unit having only a high pressure separator.

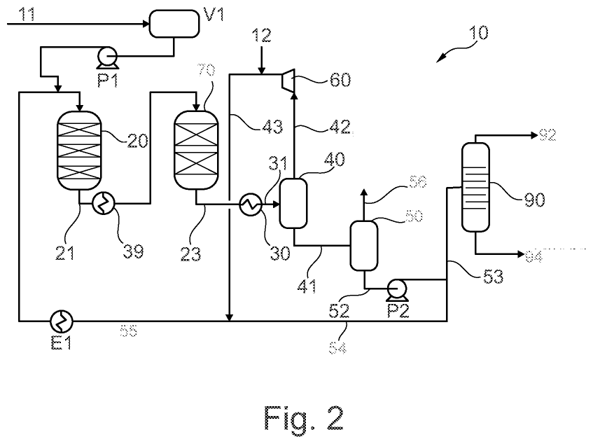

FIG. 2 shows a simplified illustration of a unit having a high pressure separator and a low pressure flash unit.

### DETAILED DISCLOSURE

In the following the abbreviation % vol shall be used to signify volume percentage for a gas.

A hydrotreatment unit for an oxygenate feedstock is provided. The term “hydrotreatment unit” includes various reactors, separators or other processing units, supplied by various feeds as required and connected by tubing, valves, connectors etc. as required, so that the appropriate product streams are provided. A hydrotreatment unit is typically one unit in a renewable fuels plant, e.g. a renewable diesel plant.

Oxygenate feedstocks may comprise one or more oxygenates taken from the group consisting of triglycerides, fatty acids, resin acids, ketones, aldehydes or alcohols where said oxygenates originate from one or more of a biological source, a gasification process, a pyrolysis process, Fischer-Tropsch synthesis, methanol based synthesis or a further synthesis process. Some of these feedstocks may contain aromatics; especially products from pyrolysis processes or waste products from e.g. frying oil. Preferably the oxygenate feedstock is a renewable oxygenate feedstock, e.g. one obtained from a raw material of renewable origin, such as originating from plants, algae, animals, fish, vegetable oil refining, domestic waste or industrial organic waste such as tall oil or black liquor.

Hydrotreatment removes many of the impurities associated with renewable feedstocks, such as oxygen-containing, sulfur-containing or nitrogen-containing impurities. Such impurities can effect later processes such as hydroisomerization.

Hydrotreatment typically takes place over a supported catalyst, typically a metal catalyst supported on a support material. The catalyst typically comprises an active metal (sulfided base metals such as nickel, cobalt, tungsten and/or molybdenum, but possibly also either elemental noble metals such as platinum and/or palladium) and a refractory support (such as alumina, silica or titania, or combinations thereof).

The hydrotreatment unit comprises:
a hydrotreatment reactor;
a first cooling unit;
a high-pressure separator; and
a low pressure flash unit.

The hydrotreatment reactor is the portion of the hydrotreatment unit which performs the hydrotreatment step. It is therefore arranged to receive the oxygenate feedstock and convert it to a hydrotreated first hydrocarbon stream. The hydrotreatment reactor comprises one or more reactor vessels, each one of which comprises 1 or more catalyst beds (typically 3-4 catalyst beds) of the supported catalyst described above. The hydrotreatment reactor requires a feed of hydrogen, which—as set out herein—can be at least partially provided by an H₂-rich stream.

Hydrotreatment conditions typically involve a temperature in the interval 250-400° C., a pressure in the interval 30-150 Bar, and a liquid hourly space velocity (LHSV) in the interval 0.1-2. Hydrotreatment is typically exothermal, and with the presence of a high amount of oxygen-containing compounds, the process may involve intermediate cooling e.g. by quenching with cold hydrogen, feed, hydrocarbon recycle or product. The feedstock may preferably contain an amount of sulfur to ensure sulfidation of the metals, in order to maintain their activity. If the feedstock comprises less than 10, 50 or 100 ppmw sulfur, a sulfide donor, such as dimethyldisulfide (DMDS) may be added to the feed.

For hydrotreatment of oxygenates the amount of hydrogen required is high, as the amount of oxygen in the feedstock may be above 5 wt % or 10 wt %- and even as high as 40 wt % for specific feedstocks from e.g. pyrolysis processes. This calls for a very high ratio between H₂ rich treat gas and oxygenate feedstream, such as above 200 Nm³/m³, 500 Nm³/m³ or even 1000 Nm³/m³. The pressure of chemical importance in hydrotreatment is the hydrogen partial pressure, which in practice means that a reduced gas phase purity will require an increased gas phase pressure. With such high gas streams, the cost of increased gas phase pressure is naturally of significance.

The first cooling unit is arranged to receive the hydrotreated first hydrocarbon stream from the hydrotreatment reactor and cool it to a cooled second hydrocarbon stream. Cooling in the cooling unit may be performed via heat exchange with one or more of the other streams in the hydrotreatment unit. Cooling in the cooling unit could also be performed by utility streams (e.g. cooling water or refrigerant) or air.

The high-pressure separator is arranged to receive the cooled second hydrocarbon stream from the first cooling unit and separate it into at least a hydrocarbon-rich stream, and a hydrogen-rich stream.

The high-pressure separator is a vessel that separates the second hydrocarbon stream into a gas stream, a liquid hydrocarbon stream and optionally a water stream. The vessel may be equipped with devices to aid in the separation of phases such as baffles, demisters or packings.

The low pressure flash unit is arranged to receive the hydrocarbon-rich stream from said high-pressure separator unit and de-gas it at lower pressure than the high-pressure separator; thereby providing an off-gas and a degassed hydrocarbon-rich stream. The low-pressure flash unit may be equipped with devices to aid in the separation of phases such as baffles, demisters or packings.

The hydrotreatment unit is suitably arranged to provide a part of the degassed hydrocarbon-rich stream from the low pressure flash unit as a hydrocarbon product stream.

The low pressure flash unit operates at a pressure of between ambient pressure and 30 barg, preferably between ambient pressure and 15 barg. The choice of pressure of this flash unit will be site-specific, and depends on where the flashed off-gas is sent. If sent to the flare system, only a low pressure (ca. 0.3 barg) would be required. If sent as fuel gas, a pressure of 3-5 barg would be suitable. If sent to H₂ recovery, a pressure of 25-30 barg would be suitable.

The hydrogen-rich gas stream from the (hot) high-pressure separator may be further cooled and separated in a further cold high-pressure separator before being directed to the hydrotreatment reactor for further purification.

The liquid of the cold high-pressure separator may be further separated in a low pressure flash unit and may either be directed as a hydrocarbon recycle stream to the hydrotreatment reactor or to a fractionator for separation into product.

Typically, the temperature in the hot high-pressure separator will be in the range 200° C. to 300° C., and if present the cold high-pressure separator will operate below 100° C.

The off-gas from this flash unit typically comprises H₂, CO, CO₂, C1 and C3 gaseous components. A certain amount of C2 and C4+ light hydrocarbons may also be present in the off-gas.

Various streams from the high-pressure separator and the low pressure flash unit are recycled to positions further upstream in the hydrotreatment unit. This helps to control temperatures in the hydrotreatment reactor.

Therefore, the hydrotreatment unit is arranged to feed at least a part of the hydrogen-rich stream from the high-pressure separator to the hydrotreatment reactor. Optionally, the entirety of the hydrogen-rich stream is fed from the high-pressure separator to the hydrotreatment reactor.

As shown in the figures an H₂ make-up feed is preferably arranged to be combined with the H₂-rich stream so as to provide treat gas. Treat gas is then fed to the hydrotreatment reactor.

Additionally, the hydrotreatment unit may be arranged to feed a part of the degassed hydrocarbon-rich stream from the low pressure flash unit as a hydrocarbon recycle stream to the hydrotreatment reactor. Notably, only a part of this stream is recycled, the remaining part is provided as a hydrocarbon product stream from the unit.

In that H₂-rich stream and hydrocarbon recycle streams are “fed to the hydrotreatment reactor”, this means that they are fed to the inlet-side of the hydrotreatment reactor. H₂-rich stream and hydrocarbon recycle stream may be fed separately to the hydrotreatment reactor, i.e. without being mixed with other gas streams. However, it may be advantageous to mix H₂-rich stream and hydrocarbon recycle stream with each other, and with other gas streams or liquid stream, prior to being fed to the hydrotreatment reactor. The recycle streams may be sent to intermediate points in the hydrotreatment reactor, such as between catalyst beds, or to different reactor vessels.

It is often advantageous to have H₂ present when the hydrocarbon recycle is heated, to prevent coke formation. In one aspect, therefore, the hydrotreatment unit is arranged to combine said H₂-rich stream or said treat gas with said hydrocarbon recycle stream to provide a combined stream which is fed to the hydrotreatment reactor.

Various streams (Hz rich stream; treat gas and hydrocarbon recycle stream) may thus be fed separately to the hydrotreatment reactor, i.e. without being combined with other streams. Alternatively, the hydrotreatment unit is suitably arranged to combine the H₂-rich stream or the treat gas with said hydrocarbon recycle stream to provide a combined stream which is fed to the hydrotreatment reactor.

The hydrotreatment unit may be arranged to combine any of the streams (Hz rich stream; treat gas and hydrocarbon recycle stream) or the combined stream with oxygenate feedstock prior to being fed to the hydrotreatment reactor.

The hydrotreatment unit preferably comprises a hydroisomerization section. The hydroisomerization section may be located as a separate reactor between the hydrotreatment reactor and said first cooling unit. The hydroisomerization section could alternatively be an additional section within the hydrotreatment reactor (with the hydroisomerization catalyst located downstream the hydrotreatment catalyst).

The hydroisomerization section is arranged to receive said hydrotreated first hydrocarbon stream from said hydrotreatment reactor, perform catalytic hydroisomerization of said stream and provide a dewaxed first hydrocarbon stream to said cooling unit. The hydroisomerization section comprises a hydroisomerization catalyst, which typically comprises an active metal (either elemental noble metals such as platinum and/or palladium or sulfided base metals such as nickel, cobalt, tungsten and/or molybdenum), an acidic support (typically a molecular sieve showing high shape selectivity, and having a topology such as MOR, FER, MRE, MWW, AEL, TON and MTT) and a typically amorphous refractory support (such as alumina, silica or titania, or combinations thereof). The catalytically active material may comprise further components, such as boron or phosphorous.

Hydroisomerization conditions typically involve a temperature in the interval 250-350° C., a pressure in the interval 20-100 Bar, and a liquid hourly space velocity (LHSV) in the interval 0.5-8.

A second heating or cooling unit may be located in the hydrotreated first hydrocarbon stream between the hydrotreatment reactor and the hydroisomerization reactor.

Following low-pressure degassing in the low pressure flash unit, the pressure of various streams may have to be raised, before being recycled to the hydrotreatment reactor. For instance, the hydrotreatment unit may further comprise a first compressor arranged to compress the H₂-rich stream. FIG. 2 shows this first compressor located upstream the H₂ make-up feed. A second pump may also be arranged to compress the combined stream fed to the hydrotreatment reactor.

In a second aspect, a renewable diesel plant is provided which comprises the hydrotreatment unit described herein, and a separation unit. The diesel plant is arranged such that at least a part of said degassed hydrocarbon-rich stream is fed from the hydrotreatment unit (more precisely from the low pressure flash unit) to the separation unit and purified to provide at least a diesel product. Light products are also provided by the separation unit.

All details of the hydrotreatment unit set out above are applicable to the renewable diesel plant of the invention, mutatis mutandis.

In a third aspect, a method for hydrotreating an oxygenate feedstock using the hydrotreatment unit described herein is provided. The method comprises the general steps of:
i. feeding said oxygenate feedstock to the hydrotreatment reactor; and converting it to a hydrotreated first hydrocarbon stream;
ii. feeding said hydrotreated first hydrocarbon stream from said hydrotreatment reactor to said cooling unit and cooling it to a cooled second hydrocarbon stream;
iii. feeding the cooled second hydrocarbon stream from said cooling unit to said high-pressure separator, and separating it into at least a hydrocarbon-rich stream, and a hydrogen-rich stream;
iv. feeding the hydrocarbon-rich stream from said high-pressure separator to said low pressure flash unit, and de-gassing it; thereby providing an off-gas and a degassed hydrocarbon-rich stream,
v. feeding at least a part of the hydrogen-rich stream from the high-pressure separator as an H₂-rich stream to the hydrotreatment reactor;
vi. separating the degassed hydrocarbon-rich stream from the low pressure flash unit into a hydrocarbon product stream and a hydrocarbon recycle stream; and
vii. feeding said hydrocarbon recycle stream to the hydrotreatment reactor.

All details of the hydrotreatment unit set out above are applicable to the method of the invention, mutatis mutandis.

In particular, the low pressure flash unit may operate at a pressure of between ambient pressure and 30 barg, preferably between ambient pressure and 15 barg. Similarly, the high pressure separator may operate at a pressure of between 20-100 barg, preferably between 30-80 barg.

The method may further comprise a step of performing catalytic hydroisomerization on the hydrotreated first hydrocarbon stream from said hydrotreatment reactor, and providing a dewaxed first hydrocarbon stream to the cooling unit. Suitable hydroisomerization catalysts and conditions are set out above.

### DETAILED DESCRIPTION OF THE FIGURES

FIG. 1 shows an oxygenate hydrocarbon feedstock 11. This stream is sent to a feed surge drum V1 and then fed to a high pressure system by pump P1. The feedstock is combined with a heated hydrocarbon recycle steam and a hydrogen-rich recycle gas stream (55), before being sent to a hydrotreating reactor (20). This first reactor contains catalyst active for hydrotreatment, and this catalyst catalyzes conversion of the oxygen present in the hydrocarbon feedstock to water, CO₂ and CO, as well as other reactions like saturation of olefins to paraffins, conversion of nitrogen to ammonia and conversion of sulfur to hydrogen sulfide. The hydrotreated product stream (21) is optionally heated or cooled by heat exchanger (39) and then sent to a hydroisomerization reactor (70). This second reactor contains catalyst active for hydroisomerization, and this catalyst converts linear paraffins with a high pour point to branched iso-paraffins with a lower pour point, and thereby improves the cold flow properties of the stream. The hydroisomerized product (23) is cooled by heat exchange with other process streams, cooling water and/or ambient air in a cooling unit (30), and the cooled stream (31) is sent into a high pressure separator (40). This separator splits the hydrotreated and hydroisomerized product into a hydrogen-rich gas stream (42), a hydrocarbon-rich liquid stream (52), and optionally a water-rich liquid stream (not shown). The hydrogen-rich stream is sent to a recycle gas compressor (60), and re-compressed gas stream is combined with hydrogen make-up gas (12) into treat gas (43) and then combined with recycle hydrocarbon stream (54). The hydrocarbon-rich liquid stream (52) is passed through pump P2, and then split into a liquid recycle hydrocarbon stream (54) and a hydrocarbon product stream (53). The liquid recycle hydrocarbon stream (54) is combined with the treat gas (43) and heated in heat exchanger E1 to achieve the proper reaction temperature in the hydrotreating reactor (20). The hydrocarbon product stream (53) is sent to a separation unit (90), where the main liquid product diesel (94) is stabilized by removal of light components (92) like naphta, LPG and fuel gas.

FIG. 2 shows an oxygenate hydrocarbon feedstock 11. This stream is sent to a feed surge drum V1 and then fed to a high pressure system by pump P1. The feedstock is combined with a heated hydrocarbon recycle steam and a hydrogen-rich recycle gas stream (55), before being sent to a hydrotreating reactor (20). This first reactor contains catalyst active for hydrotreatment, and this catalyst catalyzes conversion of the oxygen present in the hydrocarbon feedstock to water, CO2 and CO, as well as other reactions like saturation of olefins to paraffins, conversion of nitrogen to ammonia and conversion of sulfur to hydrogen sulfide. The hydrotreated product stream (21) is optionally heated or cooled by heat exchange (39) and then sent to a hydroisomerization reactor (70). This second reactor contains catalyst active for hydroisomerization, and this catalyst converts linear paraffins with a high pour point to branched iso-paraffins with a lower pour point, and thereby improves the cold flow properties of the stream. The hydroisomerized product (23) is cooled by heat exchange with other process streams, cooling water and/or ambient air in a cooling unit (30), and the cooled stream (31) is sent into a high pressure separator (40). This separator splits the hydrotreated and hydroisomerized product into a hydrogen-rich gas stream (42), a hydrocarbon-rich liquid stream (41), and optionally a water-rich liquid stream (not shown). The hydrogen-rich stream is sent to a recycle gas compressor (60), and re-compressed gas stream is combined with hydrogen make-up gas (12) into treat gas (43) and then combined with liquid recycle hydrocarbon stream (54). The hydrocarbon-rich liquid stream (41) is reduced in pressure by a valve and sent to a low pressure flash drum (50). By reducing pressure, an amount of light components is released from the liquid stream as a vapor off-gas stream (56). The remaining liquid stream (degassed hydrocarbon-rich stream 52) now contains a lower amount of light components. It is passed through pump P2, and split into a liquid recycle hydrocarbon stream (54) and a hydrocarbon product stream (53). The liquid recycle hydrocarbon stream (54) is combined with the treat gas (43) and heated in heat exchanger E1 to achieve the proper reaction temperature in the hydrotreating reactor (20). The hydrocarbon product stream (53) is sent to a separation tower (90), where the main liquid product diesel (94) is stabilized by removal of light components (92) like naphta, LPG and fuel gas.

### Example 1

Calculations of gas compositions in various streams were made, based on
1. HP separator only at 915 psig only (as per FIG. 1) (HP Only), and
2. The same HP separator, and then an LP separator (flash drum) at 150 psig (as per FIG. 2) (HP+LP sep):

| | |
|---|---|
| HP Only | HP + LP sep, |
| (915 psig in HPsep) | (150 psig in LPsep) |

| Gas | | | | |
|---|---|---|---|---|
| stream | 42 | 43 | 42 | 43 |
| H2 | 70.50 | 78.35 | 80.90 | 86.05 |
| CO | 0.75 | 0.55 | 0.65 | 0.48 |
| CO₂ | 2.71 | 1.99 | 2.06 | 1.50 |
| C1 | 17.00 | 12.48 | 8.78 | 6.41 |
| C2 | 1.23 | 0.91 | 0.90 | 0.66 |
| C3 | 6.90 | 5.07 | 5.89 | 4.30 |
| CO/CO₂ | 0.28 | 0.28 | 0.32 | 0.32 |

H₂-rich stream (42) from the HP separator Treat gas (43) (i.e. H₂ rich stream 42 mixed with make-up feed 12).

If the target is to have a hydrogen partial pressure of 50 bar, at the mixpoint of the H₂ make-up feed and the H₂-rich stream, the system pressure for the two cases will be:

HP Only: 50 bar/0.7835=63.8 bar

HP+LP sep y: 50 bar/0.8605=58.1 bar

A reduction of 10% in design pressure is thus seen, corresponding to approximately 10% savings in material and cost.

Although the invention has been described with reference to a number of aspects, examples and embodiments, these aspects, examples and embodiments may be combined by the person skilled in the art, while remaining within the scope of the present invention.

1. A hydrotreatment unit for an oxygenate feedstock, said unit (10) comprising:
a hydrotreatment reactor; said hydrotreatment reactor being arranged to receive said oxygenate feedstock and convert said oxygenate feedstock to a hydrotreated first hydrocarbon stream;
a first cooling unit arranged to receive said hydrotreated first hydrocarbon stream from said hydrotreatment reactor and cool said hydrotreated first hydrocarbon stream to a cooled second hydrocarbon stream;
a high-pressure separator arranged to receive the cooled second hydrocarbon stream from said first cooling unit and separate the cooled second hydrocarbon stream into at least a hydrocarbon-rich stream, and a H₂-rich stream;
a low pressure flash unit, said low pressure flash unit arranged to receive the hydrocarbon-rich stream from said high-pressure separator unit and de-gas the hydrocarbon-rich stream; thereby providing an off-gas and a degassed hydrocarbon-rich stream,
wherein said hydrotreatment unit is arranged to feed at least a part of the hydrogen-rich stream from the high-pressure separator to the hydrotreatment reactor; and
wherein said hydrotreatment unit is arranged to feed a part of the degassed hydrocarbon-rich stream from said low pressure flash unit as a hydrocarbon recycle stream to the hydrotreatment reactor.

2. The hydrotreatment unit according to claim 1, further comprising a hydroisomerization section located between said hydrotreatment reactor and said first cooling unit; and being arranged to receive said hydrotreated first hydrocarbon stream from said hydrotreatment reactor, perform catalytic hydroisomerization of said hydrotreated first hydrocarbon stream and provide a dewaxed first hydrocarbon stream to said first cooling unit.

3. The hydrotreatment unit according to claim 2, further comprising a second heating or cooling unit located in said hydrotreated first hydrocarbon stream between said hydrotreatment reactor and said hydroisomerization section.

4. The hydrotreatment unit according to claim 1, wherein said hydrotreatment unit is arranged to provide a part of the degassed hydrocarbon-rich stream from said low pressure flash unit as a hydrocarbon product stream.

5. The hydrotreatment unit according to claim 1, wherein said off-gas comprises H₂, CO₂, C1 and C3 gaseous components.

6. The hydrotreatment unit according to claim 1, further comprising an H₂ make-up feed, arranged to be combined with said H₂-rich stream so as to provide treat gas.

7. The hydrotreatment unit according to claim 1, further comprising a first compressor arranged to compress the H₂-rich stream.

8. The hydrotreatment unit according to claim 1, wherein said hydrotreatment unit is arranged to combine said H₂-rich stream or said treat gas with said hydrocarbon recycle stream to provide a combined stream which is fed to the hydrotreatment reactor.

9. The hydrotreatment unit according to claim 1, wherein said hydrotreatment unit is arranged to combine said at least an amount of combined stream with at least a portion of the oxygenate feedstock prior to being fed to the hydrotreatment reactor.

10. A diesel plant comprising the hydrotreatment unit according to claim 1, and a separation unit, said diesel plant arranged such that at least a part of said degassed hydrocarbon-rich stream, is fed from said hydrotreatment unit to said separation unit and purified to provide at least a diesel and/or a jet product.

11. A method for hydrotreating an oxygenate feedstock using the hydrotreatment unit according to claim 1, said method comprising the steps of:
i. feeding said oxygenate feedstock to the hydrotreatment reactor; and converting it to a hydrotreated first hydrocarbon stream;
ii. feeding said hydrotreated first hydrocarbon stream from said hydrotreatment reactor to said first cooling unit and cooling said hydrotreated first hydrocarbon stream to a cooled second hydrocarbon stream;
iii. feeding the cooled second hydrocarbon stream from said first cooling unit to said high-pressure separator, and separating the cooled second hydrocarbon stream into at least a hydrocarbon-rich stream, and a hydrogen-rich stream;
iv. feeding the hydrocarbon-rich stream from said high-pressure separator to said low pressure flash unit, and de-gassing the hydrocarbon-rich stream; thereby providing an off-gas and a degassed hydrocarbon-rich stream,
v. feeding at least a part of the hydrogen-rich stream from the high-pressure separator to the hydrotreatment reactor;
vi. separating the degassed hydrocarbon-rich stream from the low pressure flash unit into a hydrocarbon product stream and a hydrocarbon recycle stream; and
vii. feeding said hydrocarbon recycle stream to the hydrotreatment reactor.

12. The method according to claim 11, wherein the low pressure flash unit operates at a pressure of between ambient pressure and 30 barg, preferably between ambient pressure and 15 barg.

13. The method according to claim 11, wherein the high pressure separator operates at a pressure of between 20-100 barg.

14. The method according to claim 11, further comprising a step of performing catalytic hydroisomerization on the hydrotreated first hydrocarbon stream from said hydrotreatment reactor, and providing a dewaxed first hydrocarbon stream to said first cooling unit.
